(19) United States
(12) Patent Application Publication
(10) Pub. No.: US 2026/0095007 A1
(43) Pub. Date: Apr. 2, 2026

(54) CONNECTOR MODULE

(71) Applicant: Bellwether Electronic Corp., Taoyuan City (TW)

(72) Inventor: Jimmy Enrique ACERA, Taoyuan City (TW)

(21) Appl. No.: 19/319,746

(22) Filed: Sep. 5, 2025

Related U.S. Application Data
(60) Provisional application No. 63/700,768, filed on Sep. 30, 2024.

(51) Int. Cl. H01R 25/14

(52) U.S. Cl. CPC H01R 25/142

(57) ABSTRACT

A connector module includes a busbar clip (BBC) connector, a busbar connector, at least one first busbar set and at least one second busbar set. The first busbar set includes at least one first busbar. The first busbar has a first end and a second end opposite to the first end. The first end is connected with the BBC connector. The second end is connected with the busbar connector. The second busbar set includes at least one second busbar. The second busbar has a third end and a fourth end opposite to the third end. The third end is connected with the BBC connector and at least partially arranged with the first end along a first direction. The fourth end is connected with the busbar connector and at least partially arranged with the second end along a second direction intersected with the first direction.

### RELATED APPLICATIONS

This application claims priority to U.S. Provisional Application Ser. No. 63/700,768, filed Sep. 30, 2024, which is herein incorporated by reference in its entirety.

### BACKGROUND

### Technical Field

The present disclosure relates to connector modules. More particularly, the present disclosure relates to connector modules capable of transmitting a higher current flow.

### Description of Related Art

As the pace of modern life continues to accelerate, the demand for electronic devices has been steadily increasing. Facing to a huge consumer market, major manufacturers are focusing on enhancing the functionality and performance of their products, in order to boost the market competitiveness of their brands.

Taking power connectors as an example, the measure to effectively reduce their size to save space at a low cost while allowing a higher current flow under a safe condition, is undoubtedly an important issue that the industry high concerns about, which is also a target required for an urgent improvement in related fields.

### SUMMARY

A technical aspect of the present disclosure is to provide a connector module, which can allow a higher current flow and effectively reduce the space of occupation.

According to an embodiment of the present disclosure, a connector module includes a busbar clip (BBC) connector, a busbar connector, at least one first busbar set and at least one second busbar set. The first busbar set includes at least one first busbar. The first busbar has a first end and a second end opposite to the first end. The first end is connected with the BBC connector. The second end is connected with the busbar connector. The second busbar set includes at least one second busbar. The second busbar has a third end and a fourth end opposite to the third end. The third end is connected with the BBC connector and at least partially arranged with the first end along a first direction. The fourth end is connected with the busbar connector and at least partially arranged with the second end along a second direction. The second direction is intersected with the first direction.

In one or more embodiments of the present disclosure, the first busbar includes a first section, a second section and a first turning section. The first section defines the first end. The first section at least partially extends along a third direction. The third direction is intersected with the first direction and the second direction. The second section defines the second end. The second section at least partially extends along the third direction. The first turning section is connected between the first section and the second section. The first turning section at least partially extends along a first extension direction. The first extension direction is intersected with the third direction. The second busbar includes a third section, a fourth section and a second turning section. The third section defines the third end. The third section at least partially extends along the third direction. The fourth section defines the fourth end. The fourth section at least partially extends along the third direction. The second turning section is connected between the third section and the fourth section. The second turning section at least partially extends along a second extension direction. The second extension direction is intersected with the third direction.

In one or more embodiments of the present disclosure, the first section and the third section are at least partially aligned with and spaced apart from each other along the first direction. The second section and the fourth section are at least partially aligned with and spaced apart from each other along the second direction.

In one or more embodiments of the present disclosure, the first turning section includes a first connecting portion, a second connecting portion and a first curving portion. The first connecting portion is connected with the first section. The second connecting portion is connected with the second section. The first curving portion is connected between the first connecting portion and the second connecting portion. The first curving portion is at least partially curved. The second turning section includes a third connecting portion, a fourth connecting portion and a second curving portion. The third connecting portion is connected with the third section. The fourth connecting portion is connected with the fourth section. The second curving portion is connected between the third connecting portion and the fourth connecting portion. The second curving portion is at least partially curved. The second curving portion and the first curving portion are at least partially offset from each other along the first direction.

In one or more embodiments of the present disclosure, the first curving portion has at least one first curving angle. The second curving portion has at least one second curving angle. The first curving angle and the second curving angle are respectively less than 180 degrees.

In one or more embodiments of the present disclosure, the BBC connector includes a plurality of terminal sets. The terminal sets are electrically isolated from each other. The first section is connected with one of the terminal sets. The third section is connected with another one of the terminal sets.

In one or more embodiments of the present disclosure, each of the terminal sets includes a pair of outer terminals, a pair of inner terminals and a pair of conductive plates. Each of the outer terminals includes a first body and a plurality of first elastic arms. The first elastic arms are respectively connected with the first body. The first elastic arms of each of the outer terminals are spaced apart from the first elastic arms of another one of the outer terminals. The inner terminals are located between the outer terminals. Each of the inner terminals includes a second body and a plurality of second elastic arms. The second elastic arms are respectively connected with the second body. The second elastic arms of each of the inner terminals are spaced apart from the second elastic arms of another one of the inner terminals. Each of the conductive plates includes a first subsidiary conductive plate and a second subsidiary conductive plate. The second subsidiary conductive plate is connected with the first subsidiary conductive plate. The first subsidiary conductive plate is sandwiched between one of the first bodies and a corresponding one of the second bodies. The second subsidiary conductive plate is connected with one of the first section and the third section. An end of each of the second elastic arms is closer to the conductive plates than an end of each of the first elastic arms to the conductive plates.

In one or more embodiments of the present disclosure, the connector module further includes a first extension piece and a second extension piece. The first extension piece includes a first subsidiary extension piece and a second subsidiary extension piece. The first subsidiary extension piece and the second subsidiary extension piece are connected and inclined to each other. The first subsidiary extension piece is connected with at least one of the second subsidiary conductive plates of one of the terminal sets. The second subsidiary extension piece is connected with the first section. The second extension piece includes a third subsidiary extension piece and a fourth subsidiary extension piece. The third subsidiary extension piece and the fourth subsidiary extension piece are connected and inclined to each other. The third subsidiary extension piece is connected with at least one of the second subsidiary conductive plates of another one of the terminal sets. The fourth subsidiary extension piece is connected with the third section.

In one or more embodiments of the present disclosure, quantities of the first busbar set, the second busbar set and the busbar connector are respectively plural. The busbar connectors are spaced apart from each other. The first section of each of the first busbar sets is connected with one of the terminal sets. The second section is connected with a corresponding one of the busbar connectors. The third section of each of the second busbar sets is connected with another one of the terminal sets. The fourth section is connected with another corresponding one of the busbar connectors.

In one or more embodiments of the present disclosure, the busbar connector includes a plurality of conductive portions and a plurality of conductive sleeves. The conductive portions are spaced apart from each other. Each of the conductive portions includes a conductive body and a conductive connecting plate. The conductive body has a through hole. The conductive connecting plate is connected with the conductive body. The conductive sleeves are respectively disposed in the through hole of a corresponding one of the conductive portions. The second section is connected with the conductive connecting plate of a corresponding one of the conductive portions. The fourth section is connected with the conductive connecting plate of another corresponding one of the conductive portions.

According to an embodiment of the present disclosure, a connector module includes a busbar clip (BBC) connector, a busbar connector, a first busbar set and a second busbar set. The BBC connector has a plurality of first connecting points. The first connecting points are arranged along a first direction. The busbar connector has a plurality of second connecting points. The second connecting points are arranged along a second direction. The second direction intersects with the first direction. The first busbar set includes a plurality of first busbars. The first busbars are respectively connected between one of the first connecting points and one of the second connecting points. The second busbar set includes a plurality of second busbars. The second busbars are respectively connected between another one of the first connecting points and another one of the second connecting points.

In one or more embodiments of the present disclosure, each of the first busbars has a first end section and a second end section. The second end section is opposite to the first end section. The first end section is connected with one of the first connection points. The second end section is connected with one of the second connection points. The first end section and the second end section respectively extend outwardly along a third direction. The third direction intersects with the first direction and the second direction. Each of the second busbars has a third end section and a fourth end section. The fourth end section is opposite to the third end section. The third end section is connected with another one of the first connection points. The second end section is connected with another one of the second connection points. The third end section and the fourth end section respectively extend outwardly along the third direction.

In one or more embodiments of the present disclosure, the first end section and the second end section of at least one of the first busbars have a height difference along the first direction.

In one or more embodiments of the present disclosure, each of the first busbars has at least one first curved section. The first curved section is connected between the first end section and the second end section. Each of the second busbars has at least one second curved section. The second curved section is connected between the third end section and the fourth end section.

In one or more embodiments of the present disclosure, the first end section and the second end section of each of the first busbars have a length difference along the third direction.

In one or more embodiments of the present disclosure, the first direction, the second direction and the third direction are perpendicular to each other.

In one or more embodiments of the present disclosure, the first busbars and the second busbars have respectively a rectangular cross-section.

The above-mentioned embodiments of the present disclosure have at least the following advantages:
(1) Since the first busbar set and the second busbar set, connected between the BBC connector and the busbar connector, respectively include at least one first busbar and at least one second busbar, while the first busbar and the second busbar respectively provide a larger cross-sectional area relative to traditional cables in addition to a better saving of space, the connector module can allow a higher current flow.
(2) Since the first busbar and the second busbar respectively provide a larger cross-sectional area relative to traditional cables in addition to a better saving of space, the first busbar and the second busbar can achieve a stronger structural rigidity, i.e., the first busbar and the second busbar are uneasy to be deformed. Thus, the space occupied by the connector module can be effectively saved, and the spatial interference of the connector module to the component(s) in the vicinity is effectively avoided, which facilitates to enhance the practicality of the connector module.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connector module according to an embodiment of the present disclosure;

FIG. 2 is a schematic view of the connector module of FIG. 1, in which outer structures of each of the components are omitted;

FIG. 3 is a side view of the connector module of FIG. 2;

FIG. 4 is a sectional view along the sectional line A-A of FIG. 1;

FIG. 5 is a sectional view along the sectional line B-B of FIG. 1;

FIG. 6 is a sectional view along the sectional line C-C of FIG. 1; and

FIG. 7 is a sectional view along the sectional line D-D of FIG. 1.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

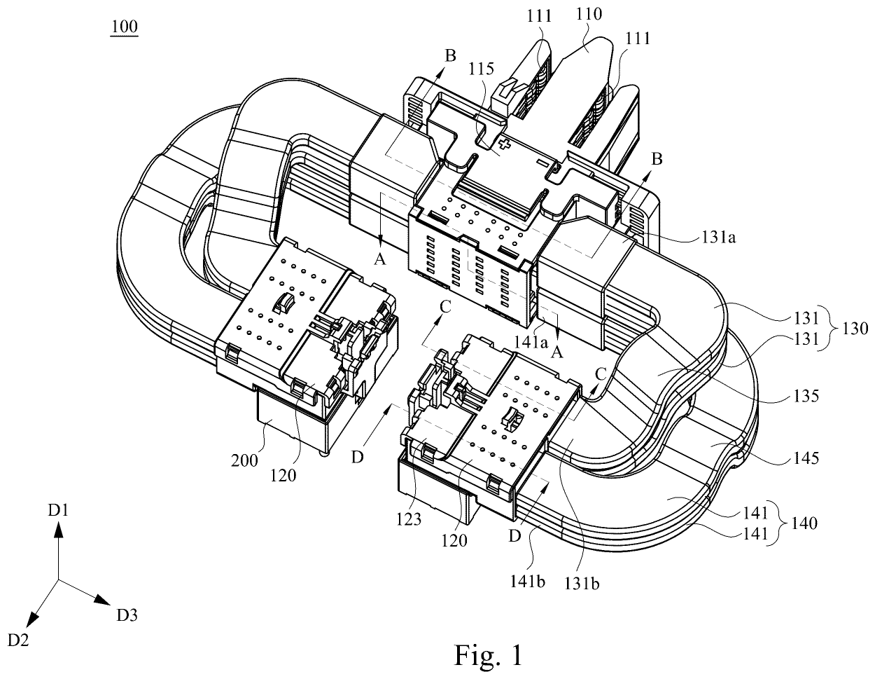

Please refer to FIG. 1. FIG. 1 is a schematic view of a connector module 100 according to an embodiment of the present disclosure. In this embodiment, as shown in FIG. 1, a connector module 100 includes a busbar clip (BBC) connector 110, a busbar connector 120, at least one first busbar set 130 and at least one second busbar set 140. The first busbar set 130 includes at least one first busbar 131. The first busbar 131 has a first end 131a and a second end 131b opposite to the first end 131a. The first end 131a is connected with the BBC connector 110. The second end 131b is connected with the busbar connector 120. The second busbar set 140 includes at least one second busbar 141. The second busbar 141 has a third end 141a and a fourth end 141b opposite to the third end 141a. The third end 141a is connected with the BBC connector 110 and at least partially arranged with the first end 131a along a first direction D1. The fourth end 141b is connected with the busbar connector 120 and at least partially arranged with the second end 131b along a second direction D2. The second direction D2 is intersected with the first direction D1. In practical applications, for example, the first direction D1 and the second direction D2 are perpendicular to each other.

Since the first busbar set 130 and the second busbar set 140, connected between the BBC connector 110 and the busbar connector 120, respectively include at least one first busbar 131 and at least one second busbar 141, while the first busbar 131 and the second busbar 141 respectively provide a larger cross-sectional area relative to traditional cables in addition to a better saving of space, the connector module 100 can allow a higher current flow.

Moreover, since the first busbar 131 and the second busbar 141 respectively provide a larger cross-sectional area relative to traditional cables in addition to a better saving of space, the first busbar 131 and the second busbar 141 can achieve a stronger structural rigidity, i.e., the first busbar 131 and the second busbar 141 are uneasy to be deformed. Thus, the space occupied by the connector module 100 can be effectively saved, and the spatial interference of the connector module 100 to the component(s) in the vicinity is effectively avoided, which facilitates to enhance the practicality of the connector module 100.

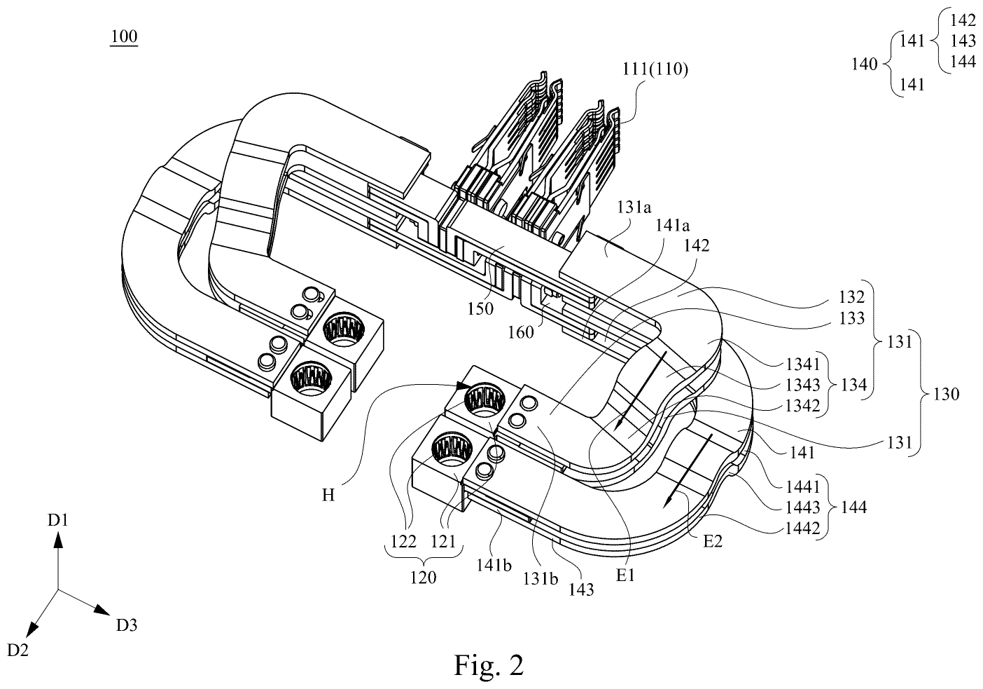

Please refer to FIG. 2. FIG. 2 is a schematic view of the connector module 100 of FIG. 1, in which outer structures of each of the components are omitted. For the sake of drawing simplification, as shown in FIG. 2, an outer casing 115 of the BBC connector 110, an outer casing 123 of the busbar connector 120, an insulating surface layer 135 of the first busbar 131 and an insulating surface layer 145 of the second busbar 141 are omitted. In this embodiment, as shown in FIGS. 1-2, the BBC connector 110 includes the outer casing 115 and a plurality of terminal sets 111. The terminal sets 111 are at least partially located inside the outer casing 115 and electrically isolated from each other. The first end 131a of the first busbar 131 is connected with one of the terminal sets 111, while the third end 141a of the second busbar 141 is connected with another one of the terminal sets 111. Moreover, the busbar connector 120 includes the outer casing 123 and a plurality of conductive portions 121. The conductive portions 121 are located inside the outer casing 123 and spaced apart from each other along the second direction D2. The second end 131b of the first busbar 131 is connected with one of the conductive portions 121, while the fourth end 141b of the second busbar 141 is connected with another one of the conductive portions 121. In addition, as shown in FIGS. 1-2, the insulating surface layer 135 covers around the first busbar 131 and exposes two opposite ends of the first busbar 131, while the insulating surface layer 145 covers around the second busbar 141 and exposes two opposite ends of the second busbar 141.

To be specific, as shown in FIG. 2, the first busbar 131 includes a first section 132, a second section 133 and a first turning section 134. The first section 132 defines the first end 131a. The first section 132 at least partially extends along a third direction D3. The third direction D3 is intersected with the first direction D1 and the second direction D2. For example, the third direction D3 is perpendicular to the first direction D1 and the second direction D2. The second section 133 defines the second end 131b. The second section 133 at least partially extends along the third direction D3. The first turning section 134 is connected between the first section 132 and the second section 133. The first turning section 134 at least partially extends along a first extension direction E1. The first extension direction E1 is intersected with the third direction D3. In practice, as shown in FIGS. 1-2, the insulating surface layer 135 covers around the first turning section 134, a portion of the first section 132 and a portion of the second section 133. Moreover, as shown in FIG. 2, the second busbar 141 includes a third section 142, a fourth section 143 and a second turning section 144. The third section 142 defines the third end 141a. The third section 142 at least partially extends along the third direction D3. The fourth section 143 defines the fourth end 141b. The fourth section 143 at least partially extends along the third direction D3. The second turning section 144 is connected between the third section 142 and the fourth section 143. The second turning section 144 at least partially extends along a second extension direction E2. The second extension direction E2 is intersected with the third direction D3. In practice, as shown in FIGS. 1-2, the insulating surface layer 145 covers around the second turning section 144, a portion of the third section 142 and a portion of the fourth section 143.

Furthermore, as shown in FIGS. 1-2, the first section 132 of the first busbar 131 and the third section 142 of the second busbar 141 are at least partially aligned with and spaced apart from each other along the first direction D1. The second section 133 of the first busbar 131 and the fourth section 143 of the second busbar 141 are at least partially aligned with and spaced apart from each other along the second direction D2.

In addition, as shown in FIG. 2, the first turning section 134 of the first busbar 131 includes a first connecting portion 1341, a second connecting portion 1342 and a first curving portion 1343. The first connecting portion 1341 is at least partially curved and connected with the first section 132. The second connecting portion 1342 is also at least partially curved and connected with the second section 133. The first curving portion 1343 is connected between the first connecting portion 1341 and the second connecting portion 1342. The first curving portion 1343 at least partially extends along the first extension direction E1. The first curving portion 1343 has at least one first curving angle θ1, and the first curving angle θ1 is less than 180 degrees. Moreover, the second turning section 144 of the second busbar 141 includes a third connecting portion 1441, a fourth connecting portion 1442 and a second curving portion 1443. The third connecting portion 1441 is at least partially curved and connected with the third section 142. The fourth connecting portion 1442 is also at least partially curved and connected with the fourth section 143. The second curving portion 1443 is connected between the third connecting portion 1441 and the fourth connecting portion 1442. The second curving portion 1443 at least partially extends along the second extension direction E2. The second curving portion 1443 has at least one second curving angle θ2, and the second curving angle θ2 is less than 180 degrees. It is worth to note that, the second curving portion 1443 of the second busbar 141 and the first curving portion 1343 of the first busbar 131 are at least partially offset from each other along the first direction D1.

Furthermore, in practical applications, as shown in FIGS. 1-2, quantities of the first busbar set 130, the second busbar set 140 and the busbar connector 120 are respectively two, and the busbar connectors 120 are spaced apart from each other. The first section 132 of each of the first busbar sets 130 is connected with one of the terminal sets 111, while the second section 133 is connected with a corresponding one of the busbar connectors 120. Moreover, the third section 142 of each of the second busbar sets 140 is connected with another one of the terminal sets 111, while the fourth section 143 is connected with another corresponding one of the busbar connectors 120. In addition, as shown in FIGS. 1-2, each of the first busbar sets 130 includes two first busbars 131, the first sections 132 of the two first busbars 131 are arranged along the first direction D1, while the second sections 133 are also arranged along the first direction D1. Similarly, each of the second busbar sets 140 also includes two second busbars 141. The third sections 142 of the two second busbars 141 are arranged along the first direction D1, while the fourth sections 143 are also arranged along the first direction D1.

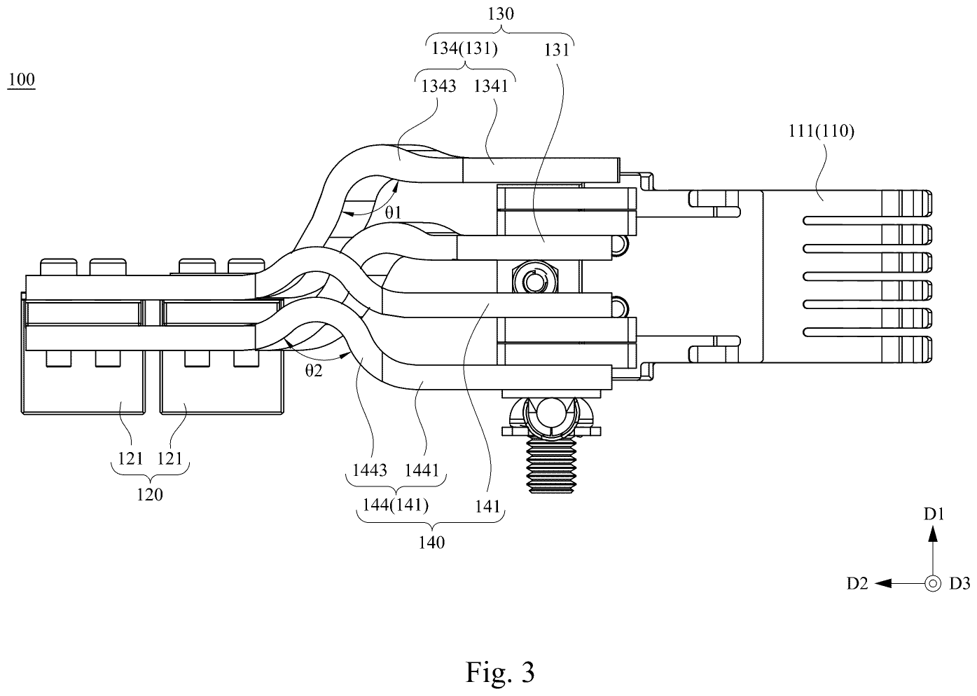

Please refer to FIG. 3. FIG. 3 is a side view of the connector module 100 of FIG. 2. In this embodiment, as shown in FIG. 3, the first curving portion 1343 and the second curving portion 1443 are respectively at least partially curved.

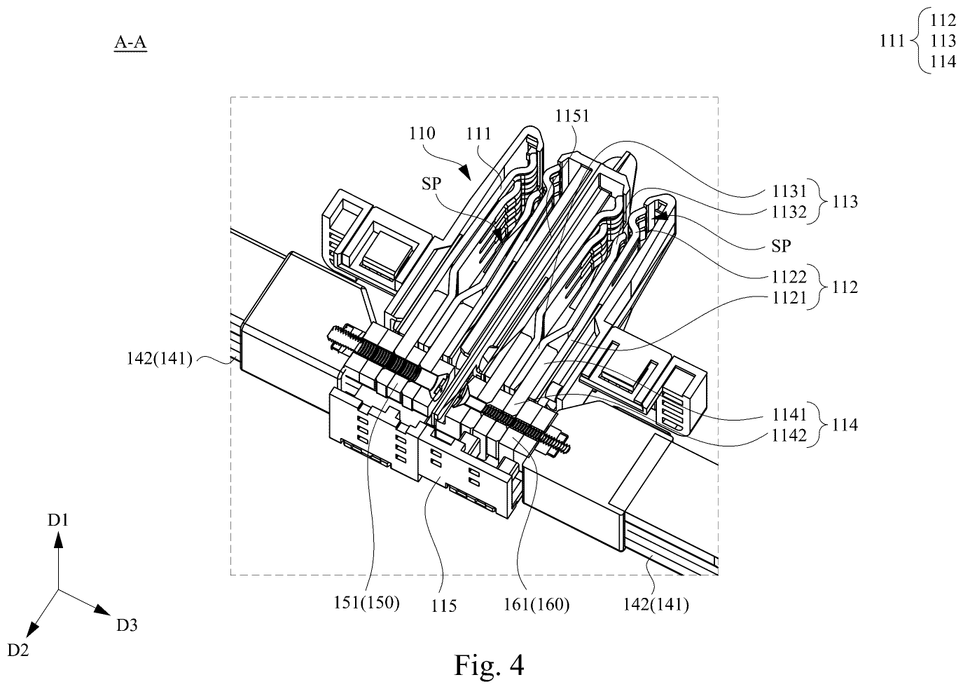

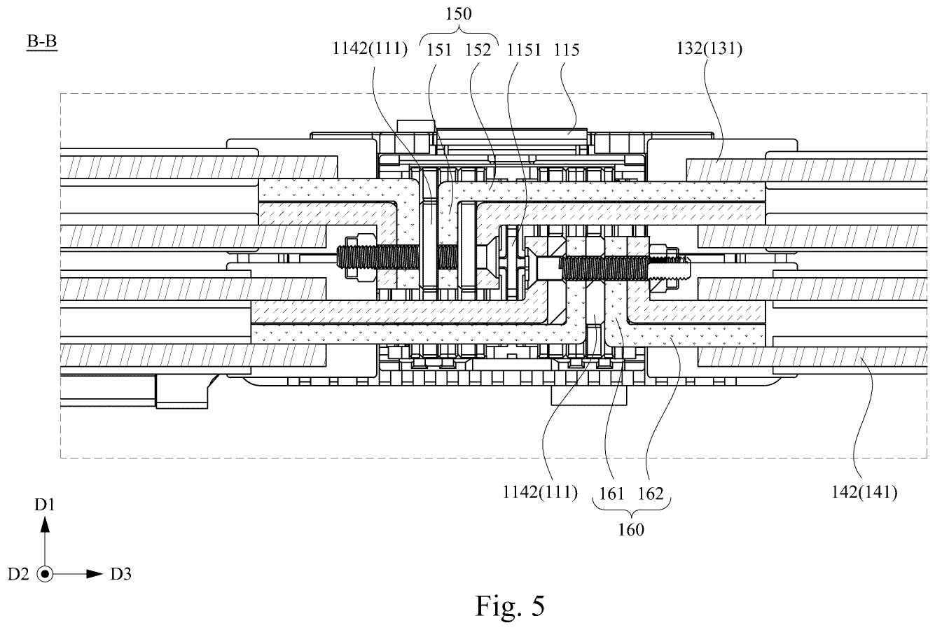

Please refer to FIGS. 4-5. FIG. 4 is a sectional view along the sectional line A-A of FIG. 1. FIG. 5 is a sectional view along the sectional line B-B of FIG. 1. In this embodiment, as shown in FIGS. 4-5, the outer casing 115 of the BBC connector 110 has an isolation wall 1151 and two accommodation spaces SP. The isolation wall 1151 isolates the accommodation spaces SP from each other. The terminal sets 111 are respectively located in the accommodation spaces SP, i.e., the terminal sets 111 are isolated from each other by the isolation wall 1151. Each of the terminal sets 111 includes a pair of outer terminals 112, a pair of inner terminals 113 and a pair of conductive plates 114. Each of the outer terminals 112 includes a first body 1121 and a plurality of first elastic arms 1122. The first elastic arms 1122 are respectively connected with the first body 1121. The first elastic arms 1122 of each of the outer terminals 112 are spaced apart from the first elastic arms 1122 of another one of the outer terminals 112. The inner terminals 113 are located between the outer terminals 112. Each of the inner terminals 113 includes a second body 1131 and a plurality of second elastic arms 1132. The second elastic arms 1132 are respectively connected with the second body 1131. The second elastic arms 1132 of each of the inner terminals 113 are spaced apart from the second elastic arms 1132 of another one of the inner terminals 113. Each of the conductive plates 114 includes a first subsidiary conductive plate 1141 and a second subsidiary conductive plate 1142. The second subsidiary conductive plate 1142 is connected with the first subsidiary conductive plate 1141. The first subsidiary conductive plate 1141 is sandwiched between one of the first bodies 1121 and a corresponding one of the second bodies 1131. The second subsidiary conductive plate 1142 is connected with one of the first section 132 and the third section 142. An end of each of the second elastic arms 1132 is closer to the conductive plates 114 than an end of each of the first elastic arms 1122 to the conductive plates 114.

Furthermore, as shown in FIGS. 1, 4-5, the connector module 100 further includes a first extension piece 150 and a second extension piece 160. The first extension piece 150 includes a first subsidiary extension piece 151 and a second subsidiary extension piece 152. The first subsidiary extension piece 151 and the second subsidiary extension piece 152 are connected and inclined to each other. For example, the first subsidiary extension piece 151 and the second subsidiary extension piece 152 are perpendicular to each other. The first subsidiary extension piece 151 is connected with at least one of the second subsidiary conductive plates 1142 of one of the terminal sets 111, and the method of connection can be achieved by a combination of bolt(s) and nut(s) as shown in FIGS. 4-5. The second subsidiary extension piece 152 is connected with the first section 132 of the first busbar 131, and the method of connection can be achieved by ultrasonic welding. The second extension piece 160 includes a third subsidiary extension piece 161 and a fourth subsidiary extension piece 162. The third subsidiary extension piece 161 and the fourth subsidiary extension piece 162 are connected and inclined to each other. For example, the third subsidiary extension piece 161 and the fourth subsidiary extension piece 162 are perpendicular to each other. The third subsidiary extension piece 161 is connected with at least one of the second subsidiary conductive plates 1142 of another one of the terminal sets 111, and the method of connection can be achieved by a combination of bolt(s) and nut(s) as shown in FIGS. 4-5. The fourth subsidiary extension piece 162 is connected with the third section 142 of the second busbar 141, and the method of connection can be achieved by ultrasonic welding.

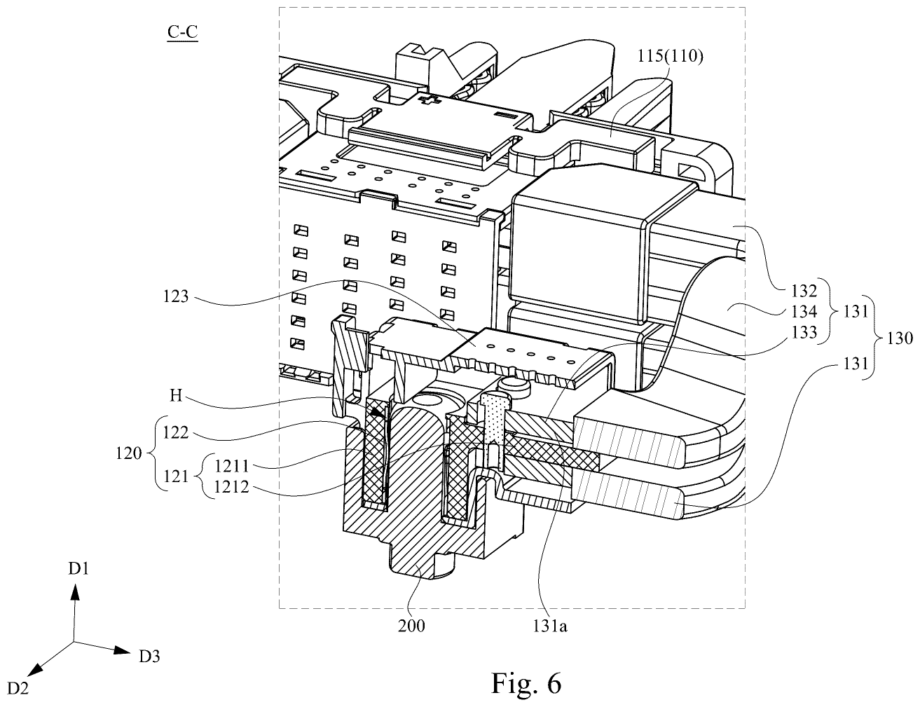

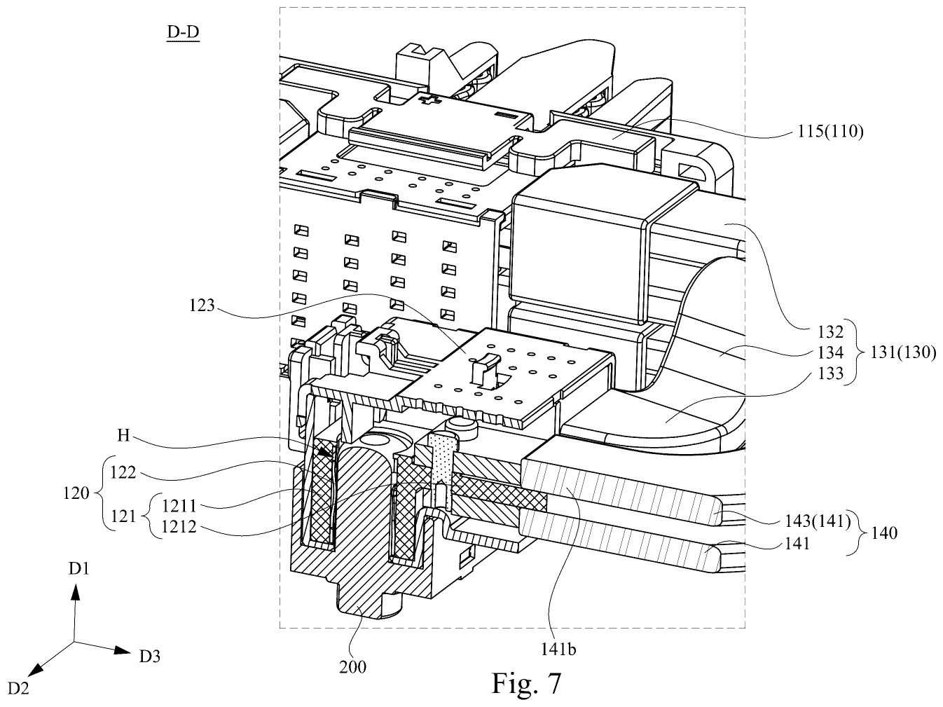

Please refer to FIGS. 2, 6-7. FIG. 6 is a sectional view along the sectional line C-C of FIG. 1. FIG. 7 is a sectional view along the sectional line D-D of FIG. 1. In this embodiment, as shown in FIGS. 2, 6-7, the busbar connector 120 includes a plurality of conductive portions 121 and a plurality of conductive sleeves 122. As mentioned above, the conductive portions 121 are spaced apart from each other along the second direction D2. Moreover, each of the conductive portions 121 includes a conductive body 1211 and a conductive connecting plate 1212. The conductive body 1211 has a through hole H. The conductive connecting plate 1212 is connected with the conductive body 1211. The conductive sleeves 122 are respectively disposed in the through hole H of a corresponding one of the conductive portions 121. As shown in FIG. 6, the second section 133 of the first busbar 131 is connected with the conductive connecting plate 1212 of a corresponding one of the conductive portions 121, and the method of connection can be achieved by a combination of bolt(s) and nut(s). A plug 200 can be at least partially inserted into the conductive sleeve 122. As shown in FIG. 7, the fourth section 143 of the second busbar 141 is connected with the conductive connecting plate 1212 of another corresponding one of the conductive portions 121, and the method of connection can be achieved by a combination of bolt(s) and nut(s). A plug 200 can be at least partially inserted into the conductive sleeve 122.

In conclusion, the aforementioned embodiments of the present disclosure have at least the following advantages:
(1) Since the first busbar set and the second busbar set, connected between the BBC connector and the busbar connector, respectively include at least one first busbar and at least one second busbar, while the first busbar and the second busbar respectively provide a larger cross-sectional area relative to traditional cables in addition to a better saving of space, the connector module can allow a higher current flow.
(2) Since the first busbar and the second busbar respectively provide a larger cross-sectional area relative to traditional cables in addition to a better saving of space, the first busbar and the second busbar can achieve a stronger structural rigidity, i.e., the first busbar and the second busbar are uneasy to be deformed. Thus, the space occupied by the connector module can be effectively saved, and the spatial interference of the connector module to the component(s) in the vicinity is effectively avoided, which facilitates to enhance the practicality of the connector module.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector module, comprising:
a busbar clip (BBC) connector;
a busbar connector;
at least one first busbar set comprising at least one first busbar having a first end and a second end opposite to the first end, the first end connecting with the BBC connector, the second end connecting with the busbar connector; and
at least one second busbar set comprising at least one second busbar having a third end and a fourth end opposite to the third end, the third end connecting with the BBC connector and at least partially arranging with the first end along a first direction, the fourth end connecting with the busbar connector and at least partially arranging with the second end along a second direction intersecting with the first direction.

2. The connector module of claim 1, wherein the first busbar comprises:
a first section defining the first end and at least partially extending along a third direction intersecting with the first direction and the second direction;
a second section defining the second end and at least partially extending along the third direction; and
a first turning section connected between the first section and the second section and at least partially extending along a first extension direction intersecting with the third direction,
the second busbar comprises:
a third section defining the third end and at least partially extending along the third direction;
a fourth section defining the fourth end and at least partially extending along the third direction; and
a second turning section connected between the third section and the fourth section and at least partially extending along a second extension direction intersecting with the third direction.

3. The connector module of claim 2, wherein the first section and the third section are at least partially aligned with and spaced apart from each other along the first direction, the second section and the fourth section are at least partially aligned with and spaced apart from each other along the second direction.

4. The connector module of claim 2, wherein the first turning section comprises:
a first connecting portion connected with the first section;
a second connecting portion connected with the second section; and
a first curving portion connected between the first connecting portion and the second connecting portion, the first curving portion is at least partially curved,
the second turning section comprises:
a third connecting portion connected with the third section;
a fourth connecting portion connected with the fourth section; and
a second curving portion connected between the third connecting portion and the fourth connecting portion, the second curving portion is at least partially curved, the second curving portion and the first curving portion are at least partially offset from each other along the first direction.

5. The connector module of claim 4, wherein the first curving portion has at least one first curving angle, the second curving portion has at least one second curving angle, the first curving angle and the second curving angle are respectively less than 180 degrees.

6. The connector module of claim 2, wherein the BBC connector comprises a plurality of terminal sets electrically isolated from each other, the first section is connected with one of the terminal sets, the third section is connected with another one of the terminal sets.

7. The connector module of claim 6, wherein each of the terminal sets comprises:
a pair of outer terminals, each of the outer terminals comprises a first body and a plurality of first elastic arms respectively connected with the first body, the first elastic arms of each of the outer terminals are spaced apart from the first elastic arms of another one of the outer terminals;
a pair of inner terminals located between the outer terminals, each of the inner terminals comprises a second body and a plurality of second elastic arms respectively connected with the second body, the second elastic arms of each of the inner terminals are spaced apart from the second elastic arms of another one of the inner terminals; and
a pair of conductive plates, each of the conductive plates comprises a first subsidiary conductive plate and a second subsidiary conductive plate connected with the first subsidiary conductive plate, the first subsidiary conductive plate is sandwiched between one of the first bodies and a corresponding one of the second bodies, the second subsidiary conductive plate is connected with one of the first section and the third section,
wherein an end of each of the second elastic arms is closer to the conductive plates than an end of each of the first elastic arms to the conductive plates.

8. The connector module of claim 7, further comprising:
a first extension piece comprising a first subsidiary extension piece and a second subsidiary extension piece, the first subsidiary extension piece and the second subsidiary extension piece being connected and inclined to each other, the first subsidiary extension piece being connected with at least one of the second subsidiary conductive plates of one of the terminal sets, the second subsidiary extension piece being connected with the first section; and
a second extension piece comprising a third subsidiary extension piece and a fourth subsidiary extension piece, the third subsidiary extension piece and the fourth subsidiary extension piece being connected and inclined to each other, the third subsidiary extension piece being connected with at least one of the second subsidiary conductive plates of another one of the terminal sets, the fourth subsidiary extension piece being connected with the third section.

9. The connector module of claim 6, wherein quantities of the first busbar set, the second busbar set and the busbar connector are respectively plural, the busbar connectors are spaced apart from each other, the first section of each of the first busbar sets is connected with one of the terminal sets, the second section is connected with a corresponding one of the busbar connectors, the third section of each of the second busbar sets is connected with another one of the terminal sets, the fourth section is connected with another corresponding one of the busbar connectors.

10. The connector module of claim 2, wherein the busbar connector comprises:
a plurality of conductive portions spaced apart from each other, each of the conductive portions comprises:
a conductive body having a through hole; and
a conductive connecting plate connected with the conductive body; and
a plurality of conductive sleeves respectively disposed in the through hole of a corresponding one of the conductive portions,
wherein the second section is connected with the conductive connecting plate of a corresponding one of the conductive portions, the fourth section is connected with the conductive connecting plate of another corresponding one of the conductive portions.

11. A connector module, comprising:
a busbar clip (BBC) connector having a plurality of first connecting points arranged along a first direction;
a busbar connector having a plurality of second connecting points arranged along a second direction intersecting with the first direction;
a first busbar set comprising a plurality of first busbars respectively connected between one of the first connecting points and one of the second connecting points; and
a second busbar set comprising a plurality of second busbars respectively connected between another one of the first connecting points and another one of the second connecting points.

12. The connector module of claim 11, wherein each of the first busbars has a first end section and a second end section opposite to the first end section, the first end section connects with one of the first connection points, the second end section connects with one of the second connection points, the first end section and the second end section respectively extend outwardly along a third direction intersecting with the first direction and the second direction, each of the second busbars has a third end section and a fourth end section opposite to the third end section, the third end section connects with another one of the first connection points, the second end section connects with another one of the second connection points, the third end section and the fourth end section respectively extend outwardly along the third direction.

13. The connector module of claim 12, wherein the first end section and the second end section of at least one of the first busbars have a height difference along the first direction.

14. The connector module of claim 12, wherein each of the first busbars has at least one first curved section connected between the first end section and the second end section, each of the second busbars has at least one second curved section connected between the third end section and the fourth end section.

15. The connector module of claim 12, wherein the first end section and the second end section of each of the first busbars have a length difference along the third direction.

16. The connector module of claim 12, wherein the first direction, the second direction and the third direction are perpendicular to each other.

17. The connector module of claim 11, wherein the first busbars and the second busbars have respectively a rectangular cross-section.
